(19) United States
(12) Patent Application Publication
(10) Pub. No.: US 2021/0164617 A1
(43) Pub. Date: Jun. 3, 2021

(54) LIQUID PROPANE INJECTION PUMP

(71) Applicant: Charles Koch, Buffalo, MN (US)

(72) Inventor: Charles Koch, Buffalo, MN (US)

(21) Appl. No.: 17/174,601

(22) Filed: Feb. 12, 2021

Related U.S. Application Data
(63) Continuation of application No. 15/439,695, filed on Feb. 22, 2017, now abandoned.
(60) Provisional application No. 62/298,830, filed on Feb. 23, 2016.
(60) Provisional application No. 62/361,179, filed on Jul. 12, 2016.

(51) Int. Cl. F17C 5/02; F04F 5/10; F04F 5/46; F04F 5/54; F17C 7/02

(52) U.S. Cl. CPC F17C 5/02; F17C 2225/0153; F04F 5/46; F04F 5/54; F17C 7/02; F17C 2201/0109; F17C 2201/054; F17C 2225/033; F17C 2221/035; F17C 2223/0153; F17C 2223/033; F17C 2201/035; F17C 2270/0171; F17C 2227/0114; F17C 2265/063; F04F 5/10

(57) ABSTRACT

A liquid propane injection pump assembly is disclosed. In one example, the liquid propane injection pump assembly includes a connection tee having first, second, and third openings. A first inlet structure can be connected to the first opening, a second inlet structure can be connected to the second opening, and an outlet structure can be connected to the third opening. The first inlet structure can include a nozzle with an external taper while the outlet structure can include a barrel with a tapered internal passageway into which the nozzle extends.

### RELATED APPLICATIONS

This application is a continuation of U.S. application Ser. No. 15/439,695, filed Feb. 22, 2017. U.S. application Ser. No. 15/439,695 claims priority to U.S. Provisional Patent Application Ser. No. 62/298,830, filed on Feb. 23, 2016 and to U.S. Provisional Patent Application Ser. No. 62/361,179, filed on Jul. 12, 2016, each of which is incorporated by reference in its entirety. A claim of priority is made, to the extent appropriate, to each of the above-referenced applications.

### FIELD OF THE DISCLOSURE

The present disclosure relates to systems for evacuating liquids from a storage tanks

### BACKGROUND

During certain operations, propane storage tanks must be evacuated. Mechanically driven pumps are currently used for such operations. However, the pumps must typically be manually positioned between a delivery truck and the propane tank which is time consuming and cumbersome. The involvement of two operators is typically required to position the pump and connect the required hoses between the pump and the delivery truck and storage tank. As importantly, due to the bulk and weight of such pumps, their movement represents an occupational hazard for the operators.

### SUMMARY

A liquid propane injection pump assembly is disclosed. In one example, the liquid propane injection pump assembly includes a connection tee having first, second, and third openings. A first inlet structure can be provided that is coupled to the connection tee first opening, wherein the first inlet structure includes a first coupling member and a nozzle. In one aspect, the nozzle extends from a first end to a second end and defines a first internal passageway and has an external surface that tapers in a direction from the first end towards the second end. A second inlet structure can also be provided that includes a second coupling member coupled to the connection tee second opening. An outlet structure can also be provided that is coupled to the connection tee third opening. The outlet structure can include a third coupling member and a barrel, wherein the barrel extends from a first end to a second end and defines a second internal passageway that includes a first tapered section proximate the barrel first end and a second tapered section proximate the barrel second end. In one example, the tapered nozzle second end extends a first distance into the first tapered section of the second internal passageway defined by the barrel.

In some examples, the barrel first tapered section is disposed at a first angle relative to a first longitudinal axis of the barrel that is greater than a second angle defined by the tapered external surface of the nozzle.

In some examples, the first angle is about 10 degrees and the second angle is about 5 degrees.

In some examples, the first distance is at least half of a first length of the barrel first tapered section.

In some examples, the first distance is between about 0.5 inch and 0.75 inch.

In some examples, the outlet structure is welded to the connection tee.

In some examples, the barrel first tapered section is a conically-shaped taper.

In some examples, the nozzle external tapered surface is a conically-shaped taper.

In some examples, the first inlet structure includes an adapter component that connects the nozzle to the first coupling member.

In some examples, the nozzle is welded to the adapter component.

In some examples, the outlet structure includes a connector piece connecting the third coupling member to the barrel.

In some examples, the third coupling member is threaded onto the connector piece and the barrel is welded to the connector piece.

In some examples, the first and second inlet structures are threaded onto the connection tee and the outlet structure is welded onto the connection tee.

In some examples, the barrel and the nozzle are formed from ASTM A106 black steel pipe.

In some examples, the connection tee is formed from ASTM A104 steel.

In some examples, the first, second, and third coupling members are ACME-type threaded couplings.

### BRIEF DESCRIPTION OF THE DRAWINGS

Non-limiting and non-exhaustive embodiments are described with reference to the following figures, which are not necessarily drawn to scale, wherein like reference numerals refer to like parts throughout the various views unless otherwise specified.

FIG. 1 is a schematic view of a liquid propane injection pump connected to a delivery truck and a storage tank in arrangements according to the present disclosure.

FIG. 1A is a schematic view of the liquid propane injection pump of FIG. 1 shown as being connected to the storage tank with an intermediate valve located therebetween.

FIG. 2 is a perspective view of the liquid propane injection pump shown in FIG. 1.

FIG. 3 is an exploded perspective view of the liquid propane injection pump shown in FIG. 2.

FIG. 4 is a side view of the liquid propane injection pump shown in FIG. 2.

FIG. 5 is a cross-sectional side view of the liquid propane injection pump shown in FIG. 4.

FIG. 6 is a top view of the liquid propane injection pump shown in FIG. 2.

FIG. 7 is a cross-sectional top view of the liquid propane injection pump shown in FIG. 6.

FIG. 8 is a first end view of the liquid propane injection pump shown in FIG. 2.

FIG. 9 is a second end view of the liquid propane injection pump shown in FIG. 2.

FIG. 10 is a cross-sectional side view of a Tapered barrel of the liquid propane injection pump shown in FIG. 2.

FIG. 11 is a cross-sectional side view of a tapered nozzle of the liquid propane injection pump shown in FIG. 2.

FIG. 12 shows a process for transferring liquid propane from a first propane storage to a second propane storage tank using the liquid propane injection pump shown in FIG. 2.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

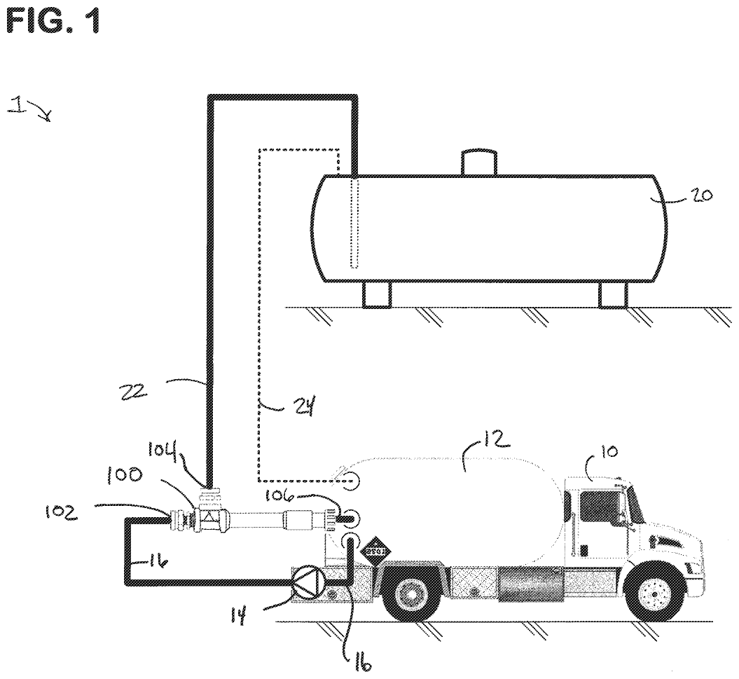

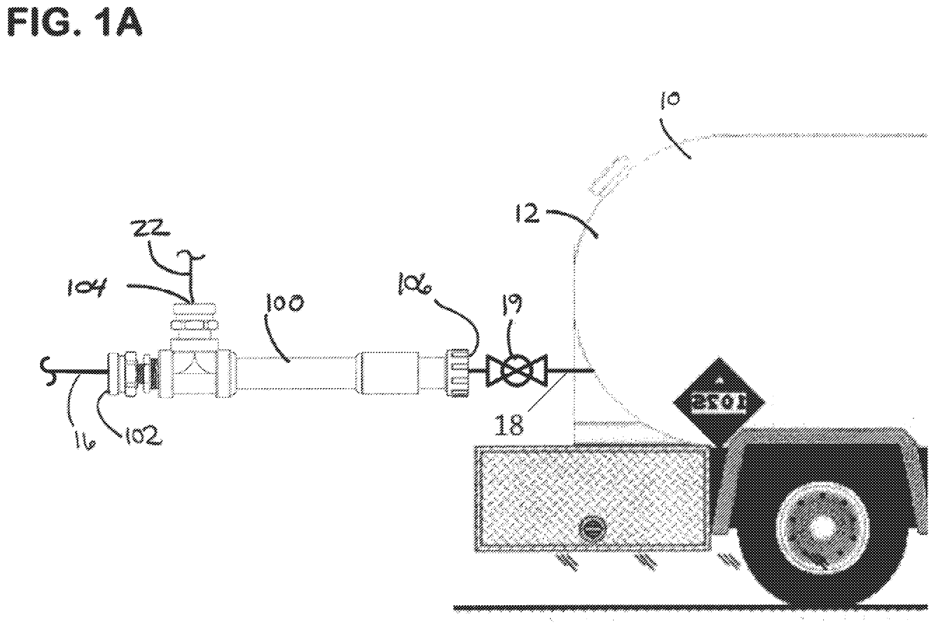

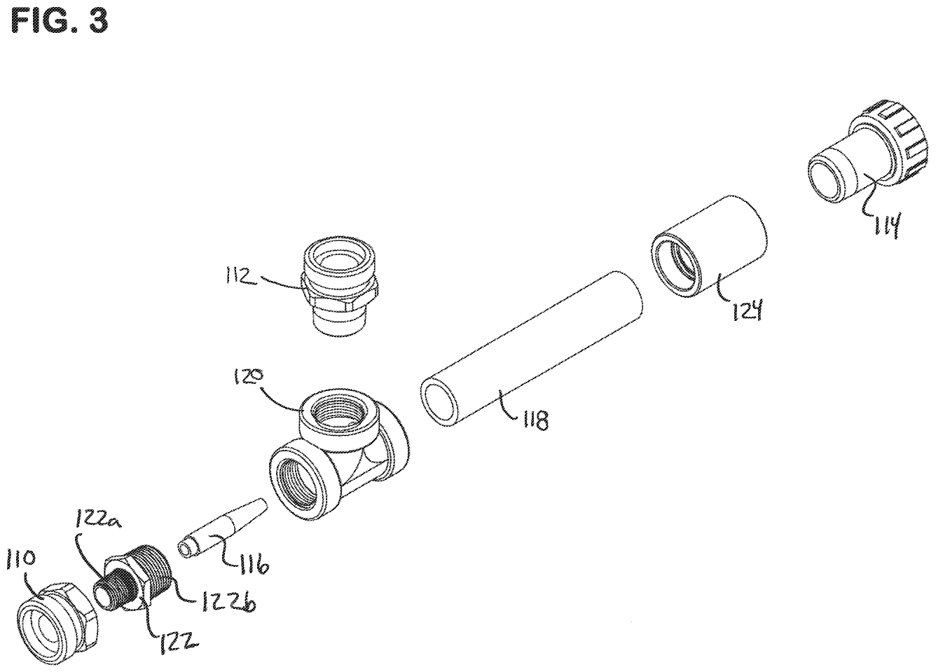

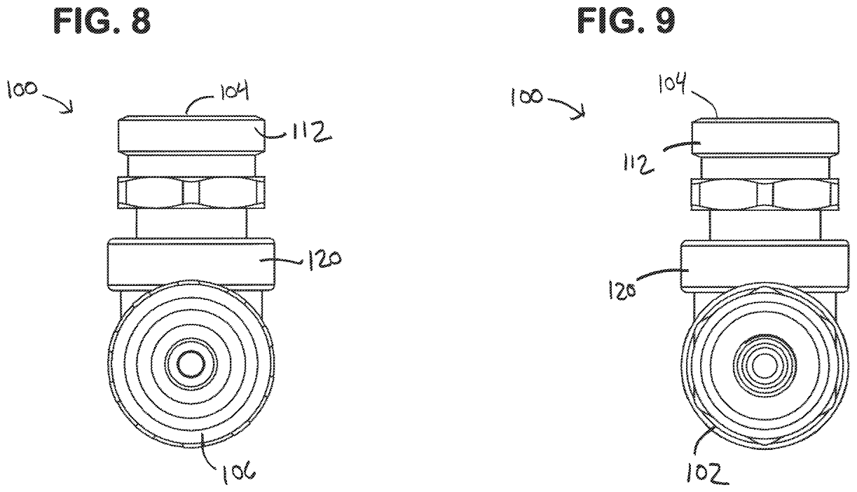

Referring to FIGS. 1 and 8, a liquid propane injection pump 100 is shown as being provided in a pumping system 1. In the configuration shown, the liquid propane injection pump 100 is utilized to transfer propane from a first tank 20 (e.g. a stationary propane storage tank) to a second tank 12 (e.g. a transportable tank mounted on a vehicle) via a process 1000. The liquid propane injection pump 100 has no moving parts and instead relies upon an internal high velocity nozzle 116 (shown at FIGS. 3, 5, 7, 11) connected to a first inlet 102 in order to induce flow from a second inlet 104 to an outlet 106. The first inlet 102 is connected to a hose 16 of a delivery truck 10 having a storage tank 12. A pump 14 is shown as being in fluid communication with the hose 16 and the storage tank 12 and is configured to pump liquid propane from the storage tank 12 through the hose 16 to the first inlet 102 of the liquid propane injection pump 100. The second inlet 104 is connected to a storage tank 20 via a hose 22. In the example shown, the storage tank 20 is a propane storage tank 20. The outlet 106 is in fluid communication with the truck storage tank 12 via the spray fill loading connection on the truck storage tank 12. A vapor equalizing line 24 must be provided between the tank 20 and the truck storage tank 12.

As discussed in more detail later, the liquid propane injection pump 100 includes a tapered nozzle that directs fluid pumped by the pump 14 into a tapered barrel that is in fluid communication with the second inlet. The liquid flowing from the tapered nozzle into the tapered barrel from the tapered nozzle creates a low pressure region in the tapered barrel, and thus the second inlet 104. This low pressure region causes propane, for example liquid propane, from the storage tank 20 to be induced into the second inlet 104 to drain the tank 20. The fluids from the inlets 102 and 104 combine within the tapered barrel and exit through the outlet 106 and discharge into the truck storage tank 12. In the embodiment shown at FIG. 1, the injection pump 100 is directly connected to a fitting on the tank 12 (i.e. not connected to an intermediate hose). Optionally, and as shown at FIG. 1A, the liquid propane injection pump 100 can be selectively isolated from the tank 12 via an isolation valve 19 and/or can be connected to the tank via a hose 18. As can be appreciated, the on-board pump 14 of the delivery truck 10 can be used in combination with the disclosed liquid propane injection pump 100 to drain the storage tank 20 without requiring the use of a separate pump that must be off loaded from the truck 10 to a location between the tanks 20, 12. This operation can be completed by a single operator.

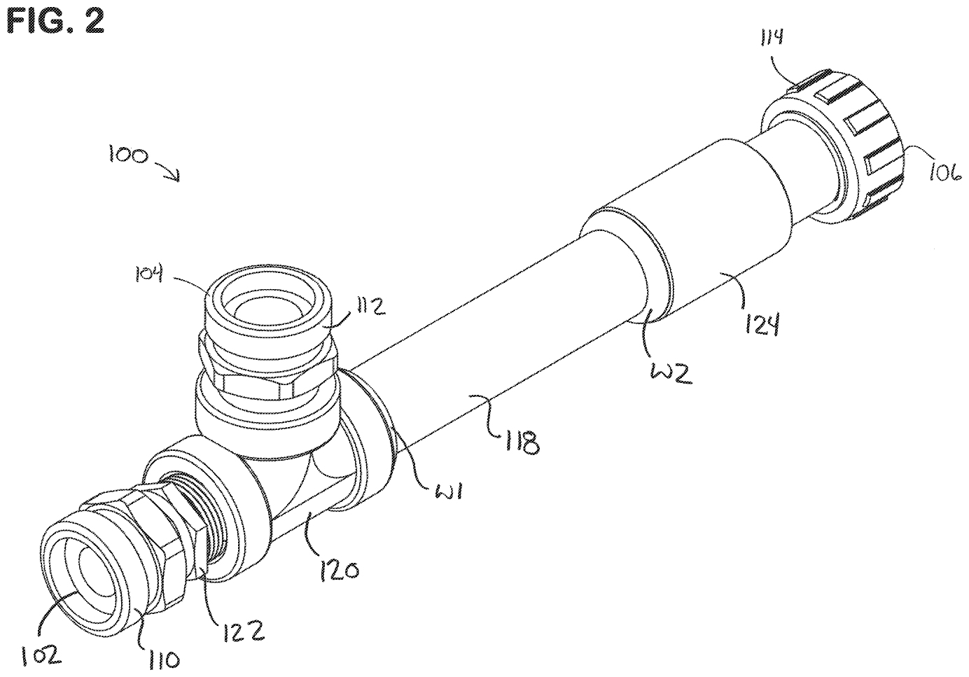

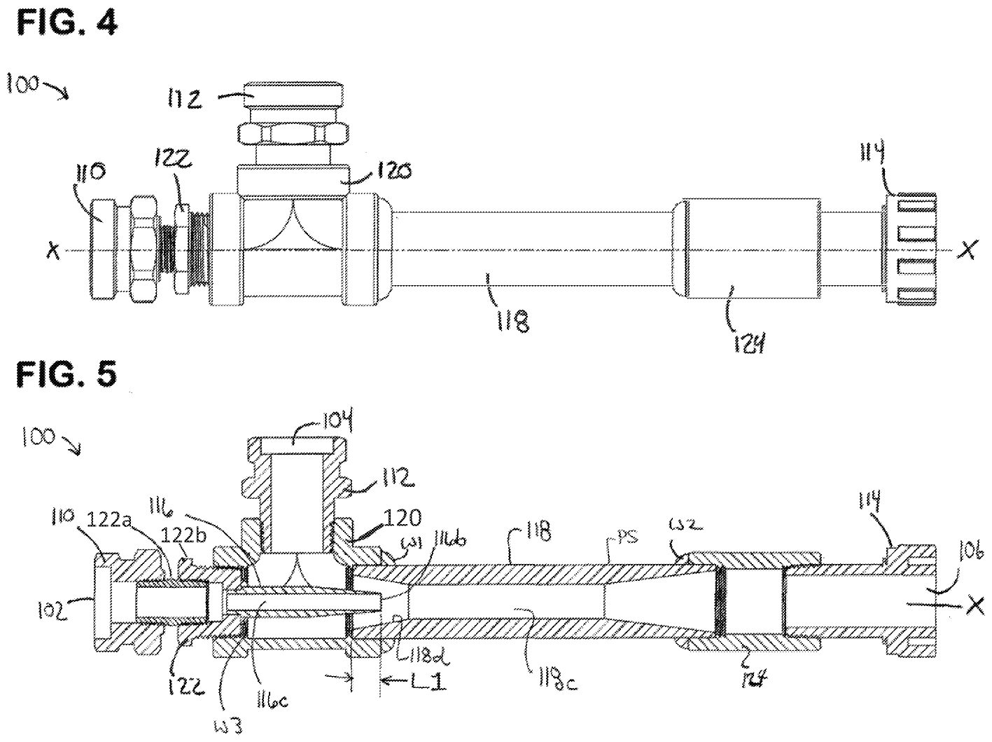

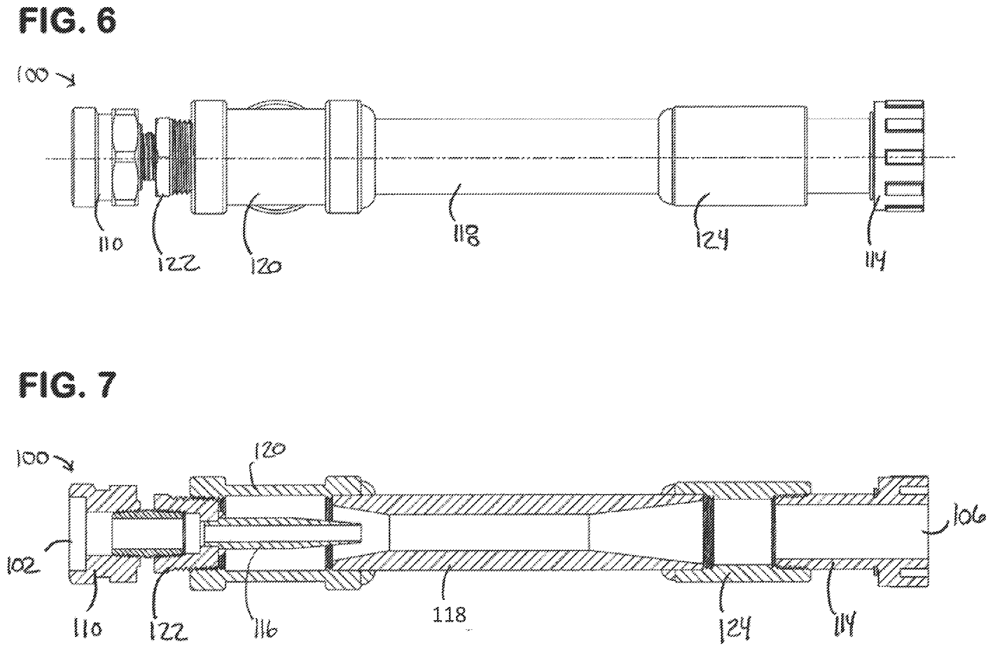

FIG. 2 shows a perspective view of the liquid propane injection pump 100. FIGS. 4 and 6 respectively show side and bottom views of the liquid propane injection pump 100 while FIGS. 8 and 9 show end views of the liquid propane injection pump 100. From these views, it can be seen that the first inlet 102 is provided with a coupling 110, the second inlet 104 is provided with a coupling 112, and the outlet 106 is provided with a coupling 114. In one example, the couplings 110, 112, 114 can be quick-connect type couplings. The couplings 110, 112, and 114 allow for the liquid propane injection pump to be respectively coupled to the hoses 16, 22, and 18. In the embodiment shown, the coupling 110 is provided with threaded ends to facilitate connection to a an adapter fitting 122 which is in turn provided with a threaded connection that facilitates connection to a first opening in a connection tee 120 of the liquid propane injection pump 100. Similarly, the coupling 112 is provided with a threaded connection to facilitate connection to a second opening of the connection tee 120. The coupling 114 is also provided with a threaded end to facilitate connection to a connector 124 of the liquid propane injection pump 100. As shown, the connector 124 provides for a connection point between a barrel 118 and the coupling 114. The barrel 118 is shown as being connected to a third opening of the connection tee 120. The barrel 118 is shown as being welded to the connection tee 120 third opening, with weld w1, and to the connector 124, with weld w2. In an alternative design, the individual components are welded together without the use of any threaded connections.

FIG. 3 is an exploded perspective view of the liquid propane injection pump 100 showing the aforementioned couplings 110, 112, 114, barrel 118, connector 124, and adapter 122. A tapered nozzle 116 is also shown. The tapered nozzle 116 is connected to the adapter 122 with a welded connection and extends through the connection tee 120 first opening. The tapered nozzle 116 can be welded or threaded to the adapter 122. In the embodiment shown, a welded connection is provided. It is noted that threads are not shown on every component in FIG. 3, although they can be seen in other views.

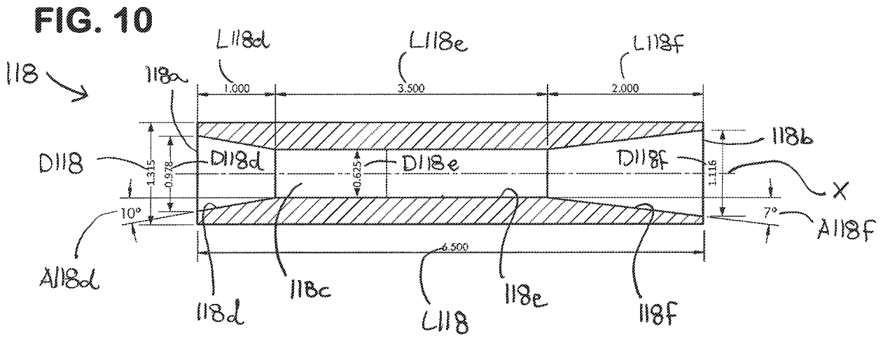

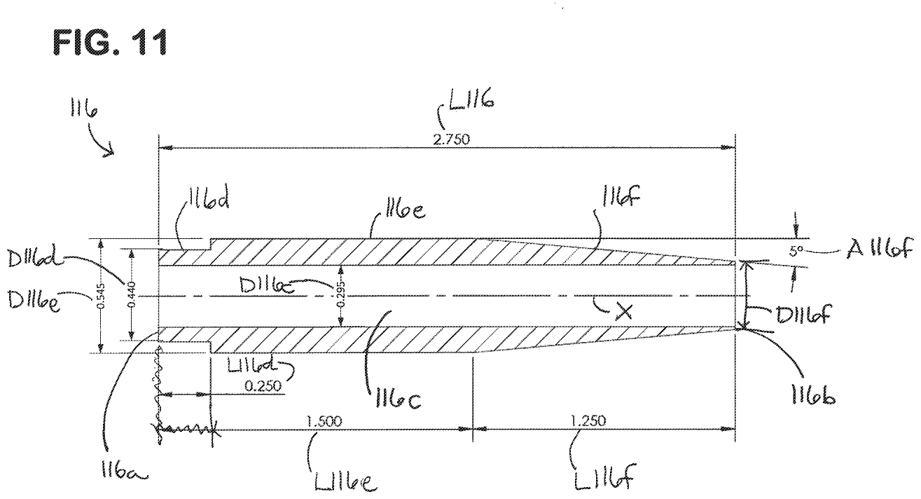

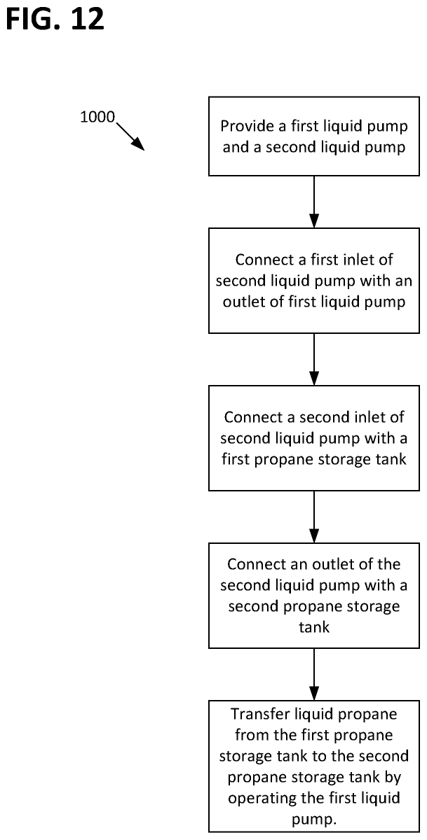

FIG. 10 shows a cross-sectional view of the tapered barrel 118. As shown, the tapered barrel 118 extends between a first end 118a and a second end 118b between which an internal passageway 118c is defined along a longitudinal axis X. The tapered barrel has an overall length L118 and an outside diameter D118. In the example shown, the length 118d is 6.5 inch while the diameter D118 is about 1.3 inch. The internal passageway 118c includes a first tapered section 118d, a central cylindrical section 118e, and a second tapered section 118f. The first tapered section 118d is shown as being provided at an angle A118d with respect to the longitudinal axis X over a length L118d. In the example shown, angle A118d is 10 degrees while length L118d is 1 inch. The central cylindrical section 118e extends between the first and second tapered portions 118d, 118f over a length L118e. In the example shown, length L118e is 3.5 inch. The second tapered section 118f is shown as being provided at an angle A118f with respect to the longitudinal axis X over a length L118f. It is noted that the tapered sections 118d and 118f are provided as straight or conical (i.e. frustoconical) tapers. Such a configuration enables the internal passageway 118c to be more easily machined in a straightforward fashion, in comparison to curved tapers.

In the example shown, angle A118f is about 7 degrees while length L118f is 2 inch. Accordingly, it should be appreciated that angle A118d is greater than angle A118f while length L118d is less than length L118f. The internal passageway 118c has an opening internal diameter D118d at the first tapered section at end 118a which reduces to an internal diameter D118e at the central cylindrical section 118e and then increases to an outlet internal diameter D118f at the second end 118b. In the example shown, the diameter D118d is about 1 inch, the diameter D118e is about 0.625 inch, and the diameter D118f is about 1.1 inch. While the above described dimensions and angles relate to a preferred embodiment, other values may also be utilized.

FIG. 11 shows a cross-sectional view of the tapered nozzle 116. As shown, the tapered nozzle 116 extends between a first end 116a and a second end 116b over a length L116. The tapered nozzle 116 also defines an internal passageway 116c having a constant internal diameter D116c extending along the longitudinal axis X. In the example shown, length L116 is 2.75 inch and the diameter D116c is about 0.3 inch. The tapered nozzle 116 also defines a shoulder section 116d, which is received into adapter 122, a central section 116e, and a tapered section 116f. The shoulder section 116d has a length L116d and a diameter D116d. The central section 116e has a length L116e and a diameter D116e. The tapered portion 116f extends over a length L116f and initially has a diameter D116e and tapers to a diameter D116f with an angle A116f. In the example shown, L116d is about 0.25 inch, L116e is about 1.25 inch, and L116f is about 1.25 inch while D116d is about 0.44 inch, D116e is about 0.545 inch, and D116f is about 0.22 inch. Angle A116f is shown as being 5 degrees. Thus, the angle A116f is less than then angle A118d. While the above described dimensions and angles relate to a preferred embodiment, other values may also be utilized.

FIGS. 5 and 7 show cross-sectional views of the liquid propane injection pump 100 showing the relationship between the nozzle 116 and the barrel 118. Many variables exist for maximizing the performance of the liquid propane injection pump 100. For example: the angle and shape of the tapered nozzle, the internal diameter of the tapered nozzle, the degree to which the nozzle extends into the tapered barrel, the angle of the inlet and outlet tapers of the tapered barrel, the maximum and minimum taper diameters of the barrel inlet and outlet, the length of the barrel tapers, the length of the straight section between the barrel tapers, and the straight section internal diameter are all factors that affect performance. In a preferred embodiment, the nozzle second end 116b extends past the barrel first end 118a and into the barrel internal passageway 118c. As shown, the nozzle second end 116b extends past the barrel first end 118a at a length L1. In a preferred embodiment, the length L1 is between about 0.5 inch and 0.75 inch, and more preferably about 0.56 inch, which is greater than half the length of the first tapered section 118d. As the tapered nozzle 116 extends into the barrel internal passageway 118c, the tapered nozzle 116 necessarily extends entirely across the third opening of the connection tee 120. As can also be seen at FIG. 5, the internal passageways 116c, 118b of the nozzle 116 and barrel 118 are coaxially aligned, as are the internal passageways defined by the coupling 110, adapter 122, connection tee 120, and coupling 114. FIGS. 5 and 7 also show that that the tapered nozzle 116 can be welded to the adapter 122 with a weld W3 and that the adapter 122 can be formed from a first threaded component 122a and a second threaded component 122b. The second component 122b can be provided as a threaded bushing which is then machined with a central bore for accepting the end of the nozzle 116. FIGS. 5 and 7 also show that the connection tee 120 is initially provided with a threaded connection at the third opening that is machined out to a larger diameter such that the barrel 118 can be inserted into the connection tee 120 and then welded to the connection tee 120 with weld w1. Optionally, connection tee 120 is provided with two threaded openings for the first and second openings and a socket connection for the third opening such that a machining step is not required. Similarly, the connector 124 can be provided with one threaded end and one socket end.

In one example, the couplings 110, 112, and 114 are brass fittings in which couplings 110, 112 are configured as ACME-type male fittings and coupling 114 is configured as an ACME-type female fitting. In one example, the connector 124, connection tee 120, and adapter 122 are formed from steel, such as ASTM A105 black steel. In one example, the barrel 118 and nozzle 116 are formed from steel pipe, such as ASTM A106 black steel pipe.

Once the aforementioned individual components are threaded together to form an assembly a leak-proof, high pressure assembly results. Examples of the finished assembly have been leak tested with pressurized air up to 250 psi and have also been hydrostatically tested to 350 psi. Additionally, the invention has been certified as being ETL listed to conform to standard “UL 119”. The finished assembly can be provided with a surface coating, such as a powder coated painted surface PS to improve durability, corrosion resistance, and aesthetics. Tests of the invention have shown that, when the pump 14 delivers about 25 gallons per minute (gpm) to the liquid propane injection pump 100 that about 12 to 15 gallons of propane (gpm) will be drawn out of the tank 20 and into the second opening 104, which is a significant improvement over prior art designs. Additionally, as the liquid propane injection pump is formed as an assembly from standard pipe and fitting components (and standard materials) with limited required machining, the disclosed invention is far more economical than other complex designs which require either heavy machining and/or casting.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the disclosure.

What is claimed is:

1. A method for draining liquid propane from a first propane storage tank, the method comprising:
a) providing a vehicle with a second propane storage tank having an inlet and an outlet, a first liquid pump in fluid communication with the outlet, and a second liquid pump in fluid communication with the inlet, the second liquid pump being a liquid propane injection pump assembly comprising:
i) a connection tee having first, second, and third openings;
ii) a first liquid propane inlet structure coupled to the connection tee first opening, the first liquid propane inlet structure including a first coupling member and a nozzle, the nozzle extending from a first end to a second end and defining a first internal passageway extending from an inlet end to an outlet end, the inlet end defining an inlet opening have a first diameter, the outlet end defining an outlet opening having a second diameter equal to the first diameter such that the first internal passageway is formed without an internal taper or a reduction in diameter, the first internal passageway having a generally constant first cross-sectional area defined by a third diameter of about 0.3 inch, and being equal to the first and second diameters, the nozzle having an external surface that tapers in a direction from the first end towards the second end with a conical taper angle of about 5 degrees
iii) a second liquid propane inlet structure including a second coupling member coupled to the connection tee second opening;
iv) a liquid propane outlet structure coupled to the connection tee third opening, the liquid propane outlet structure including a third coupling member and a barrel, the barrel extending from a first end to a second end and defining a second internal passageway that includes a first tapered section proximate the barrel first end having a conical taper angle of about 10 degrees and that includes a second tapered section proximate the barrel second end, the barrel having a central section, between the first and second tapered sections, with a second cross-sectional area defined by a fourth diameter of about 0.6 inch,
v) wherein the tapered nozzle second end extends a first distance into the first tapered section of the second internal passageway defined by the barrel, the first distance being about one inch;
b) connecting the first liquid propane inlet structure with an outlet of the first liquid pump;
c) connecting the second liquid propane inlet structure with the first propane storage tank;
d) connecting the liquid propane outlet structure with the first propane storage tank; and
e) transferring liquid propane from the first propane storage tank to the second propane tank by inducing liquid propane into the second liquid propane inlet structure by operating the first liquid pump.

2. The method of claim 1, wherein the step of connecting the first liquid propane inlet structure with an outlet of the first liquid pump includes using a threaded connection.

3. The method of claim 1, wherein the step of connecting the second liquid propane inlet structure with the first propane storage tank includes using a threaded connection.

4. The method of claim 1, wherein the step of connecting the liquid propane outlet structure with the first propane storage tank includes using a threaded connection.

5. The method of claim 1, wherein the step of providing a second liquid propane injection pump inlet structure includes attaching the tapered nozzle to an adapter and threading the adapter onto the connection tee.

6. The method of claim 5, wherein the step of attaching the tapered nozzle to the adapter includes welding the tapered nozzle to the adapter.

7. The method of claim 5, wherein the step of providing a second liquid propane injection pump inlet structure includes threading the first coupling member onto the adapter, the first coupling member having threads for coupling to a hose extending between the first and second liquid propane injection pumps.

8. The method of claim 5, wherein the step of providing a second liquid propane injection pump outlet structure, includes welding a connector to the barrel and threading the third coupling member onto the connector, the third coupling member having threads for coupling to a hose extending between the second liquid propane pump and the second propane storage tank.

9. The method of claim 1, further including the step of providing an isolation valve between the second liquid propane injection pump and the second propane storage tank.

10. The method of claim 1, further including the step of providing a vapor equalizing line extending between the first and second liquid propane storage tanks.

11. The method of claim 1, wherein the tapered nozzle can be removed from the second liquid propane injection pump by unthreading a threaded connection between an adapter supporting the nozzle and connection tee.

12. The method of claim 1, wherein the step of transferring liquid propane includes operating the first liquid pump to deliver about 25 gallons per minute to the second liquid pump and transferring 12 to 15 gallons per minute from the first liquid propane storage tank to the second liquid propane storage tank.
